(19) United States
(12) Patent Application Publication
(10) Pub. No.: US 2016/0247283 A1
(43) Pub. Date: Aug. 25, 2016

(54) SYSTEM AND METHOD FOR DIRECTIONALITY BASED ROW DETECTION

(71) Applicant: Intelescope Solutions Ltd., Petach-Tikva (IL)

(72) Inventors: Dan BEN-YAAKOV, Tel Aviv (IL); Gil SHAMIR, Kfar-Saba (IL); Roi SHILO, Moshav Benaya (IL); Alon TAIRY, Herzelia (IL); Erez Yaacov DIAMANT, Herzelia (IL)

(21) Appl. No.: 15/147,640

(22) Filed: May 5, 2016

Related U.S. Application Data
(63) Continuation of application No. 14/527,925, filed on Oct. 30, 2014, now abandoned.

(51) Int. Cl. G06T 7/00; G06T 5/00; G06T 5/20

(52) U.S. Cl. CPC G06T 7/0042; G06T 5/20; G06T 5/002

(57) ABSTRACT

A system and method for detecting and representing a directionality of objects in an image. A system and method may process an input image to produce a set of direction-filtered images, calculate a local gradient field based on the of direction-filtered images, calculate a magnitude of a projection of a local gradient on a predefined direction and use the projection to represent a directionality of the set of objects. A system and method may calculate a local orientation angle and associate the local orientation angle with pixels in an input digital image.

### CROSS REFERENCE TO RELATED APPLICATIONS

The present application is a continuation of U.S. patent application Ser. No. 14/527,925, filed on Oct. 30, 2014, which is hereby incorporated by reference in its entirety.

### FIELD OF THE INVENTION

The present invention relates generally to determining directional aspects in an image. More specifically, the present invention relates to methods, devices and systems for determining a local orientation and a regional orientation of objects in an image or map.

### BACKGROUND OF THE INVENTION

Methods for determining directional aspects in an image are known. For example, using Fourier discrete transform to identify a global directionality in an image is known in the art. Other methods, e.g., wavelet methods such as Gabor filter enable local edge detection of objects in images. However, there exist no systems or methods for detecting a directionality of periodic patterns that vary in a small length scales.

### SUMMARY OF THE INVENTION

A system and method for detecting and representing a directionality of objects in an image. A system and method may process an input image to produce a set of direction-filtered images, calculate a local gradient field based on the direction-filtered images, calculate a magnitude of a projection of a local gradient on a predefined direction and use the projection to represent a directionality of the set of objects.

A system and method may calculate a local orientation angle and a local tangent orientation. A system and method may classify sets of grid-cells in the image based on their respective local tangent orientation. A system and method may define regions having common orientation based on sets of grid-cells. A system and method may calculate a local orientation angle for a digital grayscale image having a periodic one dimensional pattern. A system and method may generate two or more gradient-filtered grayscale images using a gray-level tensor, generate an angular-gradient grayscale image based on the gradient-filtered grayscale images, associate a local orientation angle with pixels in the input digital grayscale image based on analysis of the angular-gradient grayscale image, and associate a local orientation angle with pixels in the input digital grayscale image based on the angular-gradient grayscale image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of an exemplary computing device according to embodiments of the present invention;

FIG. 2 shows exemplary images according to embodiments of the present invention;

FIG. 3 shows examples of convolution functions according to embodiments of the present invention;

FIG. 4 shows exemplary images and gradient projections according to embodiments of the present invention;

FIG. 5 shows exemplary images according to embodiments of the present invention; and

FIG. 6 is a flow according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As described, methods for determining directional aspects in an image are known, but known systems and methods do not enable detecting a directionality of periodic patterns that vary in a small length scales. Accordingly, a system and method that enable detecting small length scale periodic patterns as described herein are of great value and importance to a variety of applications. In particular, mapping of planted rows in tree plantations is an application in demand. A system and method as described herein can provide the forestry industry with an important tool that enables optimization of operational actions taken in the field.

A system and a method according to embodiments of the invention may determine a local tangent orientation and/or a local orientation angle and/or an angular-gradient. For example, using a scalar field of a local tangent orientation, the direction of rows of trees in an image may be calculated, determined and/or presented as described herein.

For example, provided with a representation of a grayscale image, a system and method may provide or generate a set of direction-filtered grayscale images, use the direction-filtered images to calculate a local gradient field, calculate a magnitude of a projection of the local gradient, calculate a local projection asymmetry based on the projection's magnitude, calculate a local orientation angle based on a local projection asymmetry, and provide or generate a representation of a local tangent orientation of objects in the grayscale image. A local gradient field may be produced by associating some (or even all) pixels in an image with a value or attribute related to the local gradient at the location of the pixel. Accordingly, representation of a directionality of a set of objects in an image may be (or made using) a representation of a local tangent orientation for the set of objects. For example, if the objects are trees in an image then representation of a directionality of the trees may reveal or show rows of trees and rows' directions.

A system and a method according to embodiments of the invention may calculate a local orientation angle for sets of objects in a digital grayscale image. For example, provided with a representation of a grayscale image that includes a set of grayscale values of a respective set of pixels in the grayscale image and a periodic pattern, a system and method may generate gradient-filtered grayscale images, use the gradient-filtered grayscale images to generate an angular-gradient grayscale image, generate or provide a local orientation angle for pixels in the grayscale image based on the angular-gradient grayscale image, and generate or provide a local orientation angle for pixels in the grayscale image based on the angular-gradient grayscale image.

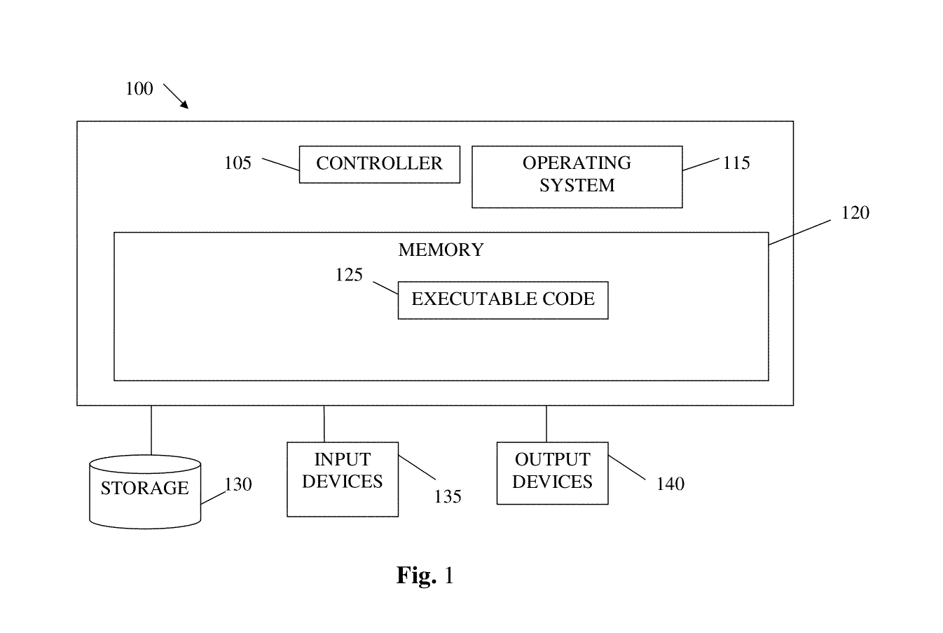

Reference is made to FIG. 1, showing high level block diagram of an exemplary computing device according to embodiments of the present invention. Computing device 100 may include a controller 105 that may be, for example, a central processing unit processor (CPU), a chip or any suitable computing or computational device, an operating system 115, a memory 120, a storage 130, input devices 135 and 1 output devices 140.

Operating system 115 may be or may include any code segment designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer or processor non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that provides a representation of a local tangent orientation of objects in a grayscale image as further described herein.

Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 130 and may be loaded from storage 130 into memory 120 where it may be processed by controller 105. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), printer, a display, a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a mobile computer, a laptop computer, a server computer, a network device, or any other suitable computing device.

The term “image” and types of images (e.g., grayscale image, directed-filtered image etc.) as referred to herein may relate to a digital representation of an image as known in the art. For example, an image as referred to herein may be a set or array of pixels, each pixel represented by a set of values, parameters or attributes, e.g., an intensity value, a color parameter or any other imaging attributes, values or parameters. The term “2-dimensional scalar field” as referred to herein may related to an image, for example, an output of processing an input image may be a 2-dimensional scalar field that includes all data included in the input image and additional data. For example, additional data may be values of a vector added to, or associated with, each pixel in the input image.

For example, a GeoTIF image, an input image, a grayscale image, a sample image, a filtered image, a filtered grayscale image, an original image, a direction-filtered image, a J-averaged grayscale image, a projection asymmetry grayscale image, a gradient-filtered grayscale image and an angular-gradient grayscale image may all be a digital representation of an image as described herein.

A GeoTIF image (or file) is known in the art. Generally, GeoTIF is a standard that enables including georeferencing information in a TIFF file. For example, georeferencing information may be information such as map projections, coordinate systems, or other spatial references that may be included in a GeoTIF image or file.

The terms “scalar field” and types of scalar fields, e.g., “2-dimensional scalar field” are known in the art. Generally, a scalar field associates one or more scalar values or quantities with each point in a space. Since a scalar field may associate more than one value with each point, a scalar field may associate complex entities with points in a space, e.g., vectors. A scalar field may assign a set of values to a point in space so it can assign a vector to a point by, for example, assigning three scalar values (that may be the X, Y and Z values along the respective axes) to a point. For example, a scalar field may associate a directionality vector angle (or any other scalar parameter or value related to directionality) to each pixel in an image. Any information associated with pixels (e.g., using, or according to, a scalar field) may be embedded in the image or it may be stored in association with the image (e.g., storing both the image and the scalar field data in a single file). Accordingly, a system or method may readily process and present (e.g., on a computer display) a scalar field such as a scalar field of a local tangent orientation. For example, presented on a display screen, a scalar field of a local tangent orientation may include small arrows placed on an image of rows of trees where the arrows indicate or show the row's tangent directions.

The term “local orientation angle” as referred to herein may relate to a directionality parameter or value associated with a point in a space. For example, in a two dimensional space of an image (e.g., each pixel is assigned X and Y coordinate values) a scalar field may associate a set of angles or orientations to a set or group of pixels in the image or to each pixel in the image. In an embodiment, a local orientation angle is an angle from a predetermined axis of a two dimensional space of an image. For example, each pixel in an image may be assigned (or associated with) a value that represents a directionality where the directionality is expressed as an angle from a known or predefined direction or angle.

The term “periodic pattern” as referred to herein may relate to a phenomena that is repeated in space with a defined periodicity length and along a known direction.

Modules or units described herein may include elements included in device 100 described herein. For example, modules or units described herein, such as, but not limited to, a local tangent orientation detection module, a statistical tangent orientation detection module, a local verification module and a border detection module, may include a controller 105, a memory 120, and an executable code 125. For example, a plurality of executable code segments similar to executable code 125 may be loaded into memory 120 and be executed by controller 105 such that a system that includes a local tangent orientation detection module, a statistical tangent orientation detection module, a local verification module and a border detection module is realized.

A method according to embodiments of the invention may include detecting a dominant directionality in a local neighborhood of a test pixel. For example, a local neighborhood may be defined by a window of pixels, e.g., a window that includes 9×9 pixels. A system according to embodiments of the invention may include a module for detecting a dominant directionality in a local neighborhood of a test pixel. For example, a local neighborhood may be the test pixel, or it may be a set of pixels included in a 16×16 window of pixels around the test pixel or around another pixel in the window.

A system and method may include receiving or providing a 2-dimensional scalar field as input that includes a periodic pattern and returning or generating a 2-dimensional scalar field that represents a local tangent orientation of points in the input 2-dimensional scalar field.

In an embodiment, the input 2-dimensional scalar field is a color or grayscale digital image that has or includes periodic one dimensional patterns and a generated 2-dimensional scalar field is a 2-dimensional scalar field of the local tangent orientation in the grayscale image.

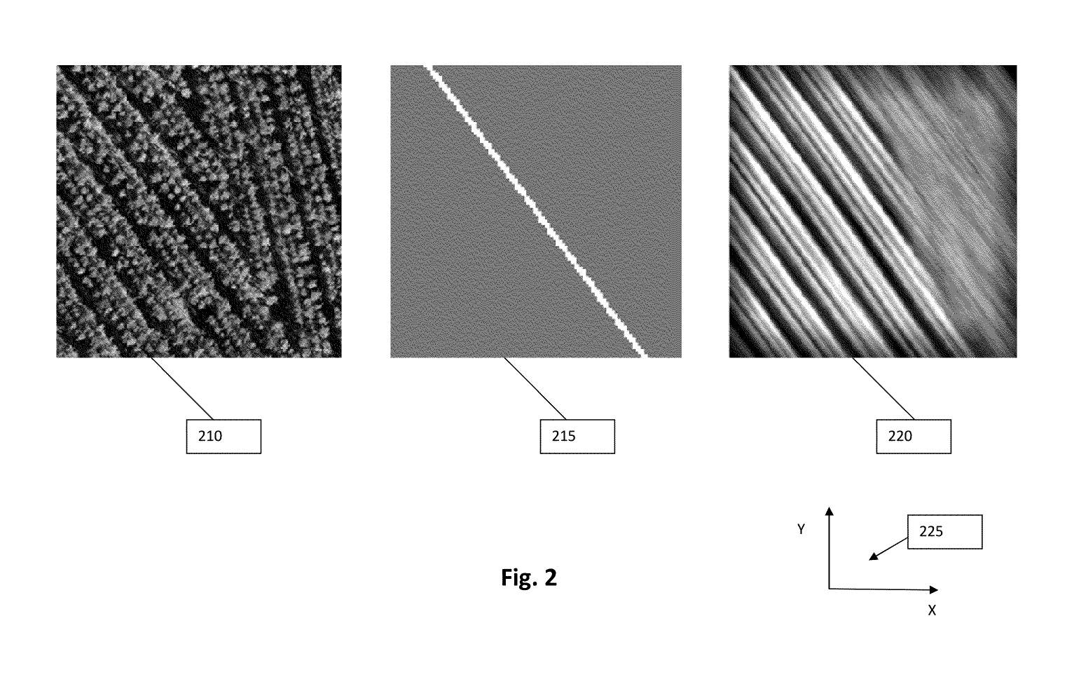

Reference is made to FIG. 2 that shows an exemplary image of rows of trees 210 and related images 215 and 220 as described herein. For example, images similar to image 210 may be used as an input 2-dimensional scalar field as described herein.

In an embodiment, the input 2-dimensional scalar field is a grayscale image where the gray value of a pixel at coordinates (x,y) is given by a 2-dimensional matrix hᵢⱼ≡h(tΔx,jΔy) where i=1 . . . Nₓ and j=1 . . . N_{y} are the horizontal and vertical pixel indices, and Δx and Δy are the horizontal and vertical pixel dimensions, respectively. As referred to herein, Nₓ and N_{y} are the image horizontal and vertical dimensions in units of pixels. For example, the input 2-dimensional scalar field is the set of pixels used to display image 210. X and Y coordinates and values discussed herein may be according to a coordinate system as shown by coordinate system 225.

A system or method may include convoluting an input grayscale image with a directional filter to generate a direction-filtered grayscale image. For example, gray-level tensor, hᵢⱼₖ^{d}≡h(xᵢ,yⱼ;θₖ) may be generated by convoluting an input grayscale image with a directional filter h^{d}ᵢⱼₖ:

$${h}_{ijk}^{d} = \frac{1}{{\sum }_{mn} {f}_{mnk}} {\sum }_{\vert m \vert < {𝓁}_{x} \text{/} 2 , \vert n \vert < {𝓁}_{y} \text{/} 2} {h}_{i + m , j + n} \cdot {f}_{mnk}^{d}$$

where lₓ and l_{y} are the convolution window size (or filter window size) in units of pixels, and the convolution function f^{d}ₘₙₖ is given by:

$${f}_{mnk}^{d} = \{ \begin{matrix}{\vert {t}_{mn} - {t}_{mn} \cdot {\hat{n}}_{k} ] \vert}^{2} \leq {d}^{2} & 1 \\ {\vert {t}_{mn} - {t}_{mn} \cdot {\hat{n}}_{k} ] \vert}^{2} > {d}^{2} & 0\end{matrix}$$

where tₘₙ=(mΔx,nΔy) is a point vector in the convolution window, \hat{n}ₖ=(cos θₖ,sin θₖ) is a unit vector along the direction of the angles {θₖ}ₖ, and d is the allowed distance of a given point in the convolution window from a straight line along the direction of \hat{n}ₖ. An exemplary direction-filtered grayscale image is shown by image 220 in FIG. 2.

As described, a periodic pattern may be a phenomena that is repeated in space (e.g., a two dimensional space in an image) with a defined periodicity length and direction. For example, a periodic pattern can be seen in the upper left portion of image 220 in FIG. 2, where the grayscale level pattern repeats itself with a well-defined length and along a known (or well-defined) direction.

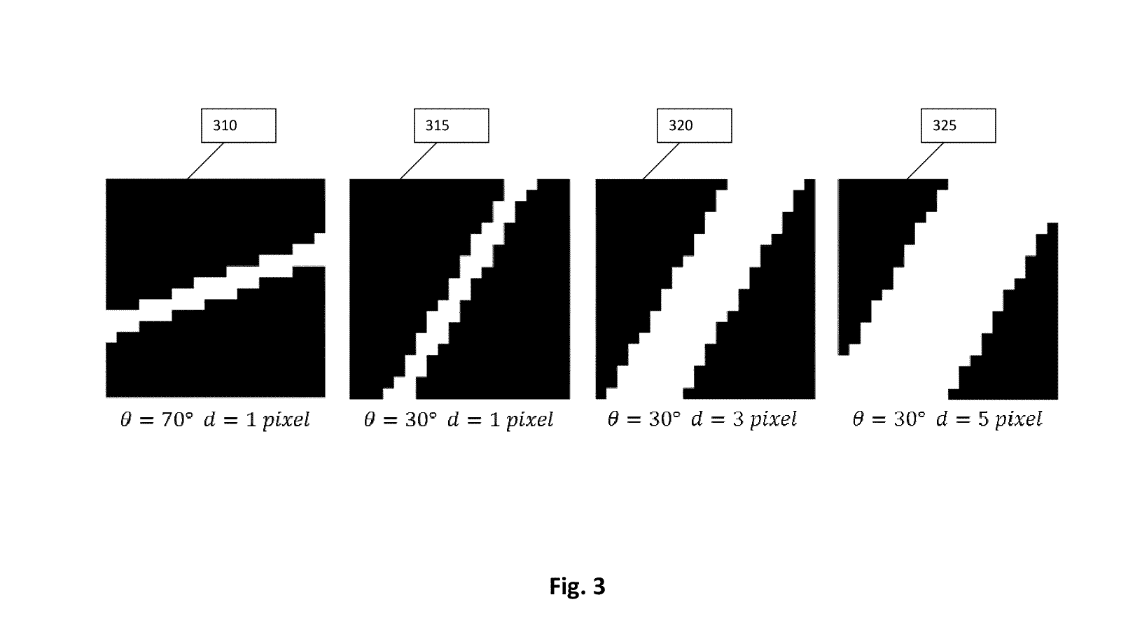

Image 215 illustrates the convolution window used for generating direction-filtered image 220. In this exemplary case, the size of the window is 101×101, the angle is θ=143° measured clockwise with respect to the upward vertical (North), and the allowed distance is d=1 pixel. Using varying filter-directionality (e.g., by using different angles as illustrated in FIG. 3 and described herein) a set of direction-filtered grayscale images may be created.

Reference is made to FIG. 3 that shows examples of convolution functions fₘₙₖ^{d}. The values taken for the angle parameter θ and the allowed distance parameter d are shown below the convolution windows 310, 315, 320 and 325. The angles are measured clockwise with respect to the upward vertical (North). The window size in the examples shown in FIG. 3 is 20×20 pixels.

A system or method may include calculating a magnitude Jᵢⱼₖₗ of a projection of the local gradient in a direction-filtered image local gradient by:

Jᵢⱼₖₗ=|Gᵢⱼₖ·\hat{m}ₗ|,

where Gᵢⱼₖ is the numerical local gradient of hᵢⱼₖ^{d}, calculated by central differences and given by:

$${G}_{ijk} = \frac{1}{2} ( \frac{{h}_{i + 1 , j , k}^{d} - {h}_{i - 1 , j , k}^{d}}{Δ x} , \frac{{h}_{i , j + 1 , k}^{d} - {h}_{i , j - 1 , k}^{d}}{Δ y} ) ,$$

and \hat{m}ₗ=(cos φₗ,sin φₗ) is a unit vector along the direction of the angles {φₗ}ₗ.

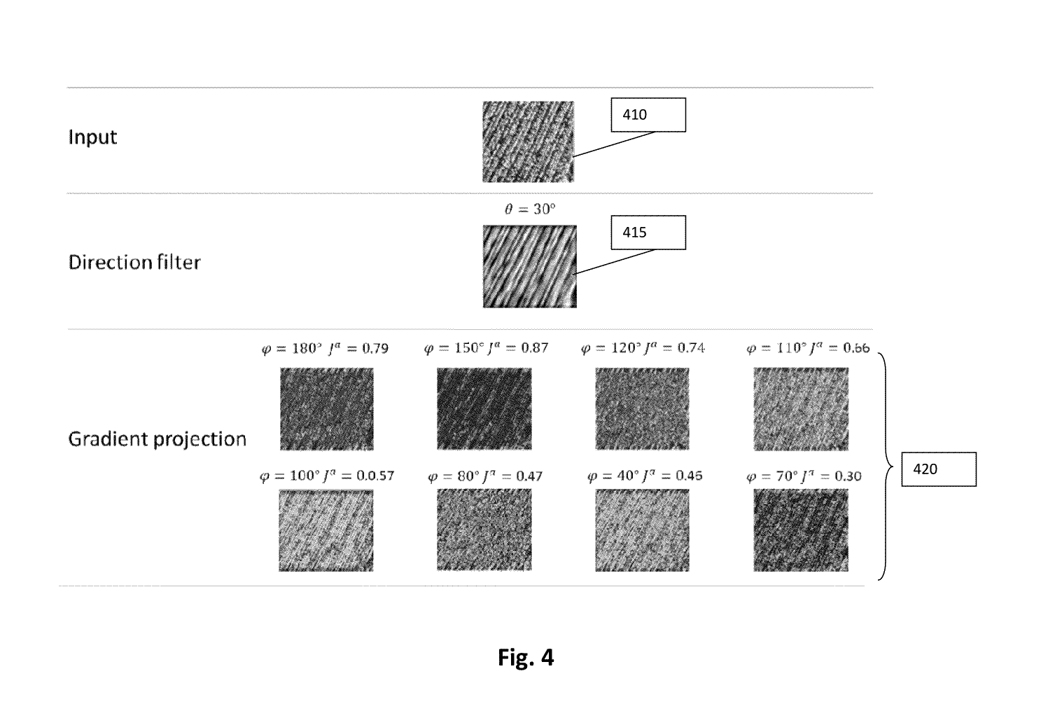

Reference is made to FIG. 4 that shows exemplary averaging and gradient projections. As shown, an input image 410 may be received and a directed-filtered image 415 may be generated for the input image. A number of projections (according to an angle and magnitude) may be generated as shown by projections 420. For example, the J^{a} values shown in gradient projection 420 may be the average of the projection for each window in gradient projection 420 as shown.

A system or method may include generating a J-averaged (^{Ja}) grayscale image. In an embodiment, a gray level tensor is used as the J-averaged grayscale image. It will be understood that the gray level tensor may be, or it may be used to generate, a set of data elements (e.g., a set of values for each pixel in an image) and the values may be saved or provided to any component in a system according to embodiments of the invention.

A system and method may include applying an averaging filter (as elaborated in the previous clause 45) to the magnitude of the projection Jᵢⱼₖₗ to produce a smoothed set of images having a respective set of smoothed gradient magnitude projections J^{a}ᵢⱼₖₗ.

In an embodiment, the gray level tensor Jᵢⱼₖₗ^{a}, is computed by convoluting Jᵢⱼₖₗ with an averaging filter:

$${J}_{ijkl}^{s} = {\sum }_{\vert m \vert < {L}_{x} \text{/} 2 , \vert n \vert < {L}_{y} \text{/} 2} {J}_{i + m , j + n , k , l} \cdot {f}_{mn}^{s}$$

where Lₓ and L_{y} are the respective dimensions defining the convolution window size (i.e. mean filter window size) in units of pixels, and the convolution function f^{a}ₘₙ is given by:

$${f}_{mn}^{s} = \frac{1}{{L}_{x} {L}_{y}} .$$

A system or method may include calculating a local projection asymmetry in a grayscale image. For example, provided with an input gray scale image, a system or method may generate a second gray scale image that is or that includes local projection asymmetry data.

For example, a local projection asymmetry grayscale image may be (or may be represented or described by) a tensor Sᵢⱼₖ, that may be calculated base on the difference between the maximal value and the minimal value of {Jᵢⱼₖₗ^{a}}ₗ with respect to {φₗ}ₗ. The maximum and minimum angles may be found, for example, using a cubic spline (see Press, William H. Numerical recipes 3rd edition: The art of scientific computing. Cambridge university press, 2007.) interpolating {Jᵢⱼₖₗ^{a}}ₗ as a function of {φₗ}ₗ, yielding a continuous function \tilde{J}ᵢⱼₖ^{a}(φ), for which the maximum angle φᵢⱼₖ^{max} and minimum angle φᵢⱼₖ^{min} may be found using numerical algorithm that is based on the golden search and parabolic interpolation. (see Press, William H. Numerical recipes 3rd edition: The art of scientific computing. Cambridge university press, 2007.) The asymmetry tensor Sᵢⱼₖ may be calculated by:

Sᵢⱼₖ=\tilde{J}ᵢⱼₖ^{a}(φᵢⱼₖ^{max})−\tilde{J}ᵢⱼₖ^{a}(φᵢⱼₖ^{min}).

The local orientation angle αᵢⱼ may be obtained by calculating the maximum of {Sᵢⱼₖ}ₖ with respect to {θₖ}ₖ. The maximum is found by cubic spline (see Press, William H. Numerical recipes 3rd edition: The art of scientific computing. Cambridge university press, 2007.) interpolating {Sᵢⱼₖ}ₖ as a function of {θₖ}ₖ, yielding a continuous function \tilde{S}ᵢⱼ(θ), for which the maximum angle θᵢⱼ^{max} may be found using numerical algorithm that is based on the golden search and parabolic interpolation (see Press, William H. Numerical recipes 3rd edition: The art of scientific computing. Cambridge university press, 2007.). Cubic spline interpolation, golden search and parabolic interpolation are all known in the art. The local orientation αᵢⱼ may then be given by:

αᵢⱼ=θᵢⱼ^{max}.

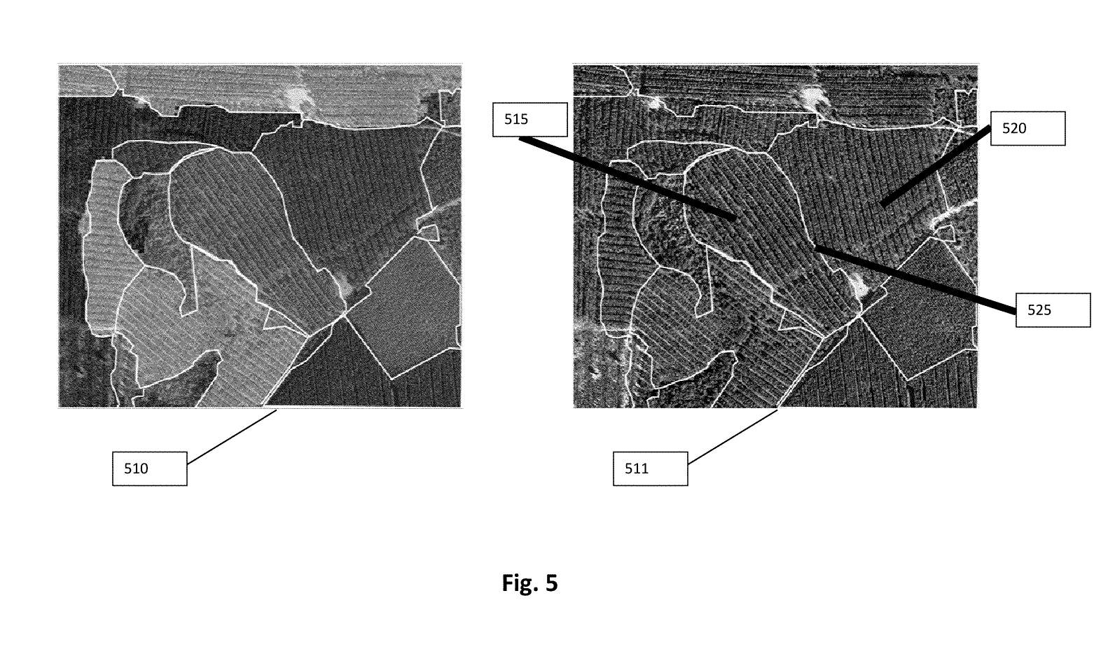

Reference is made to FIG. 5 that shows exemplary images 510 and 511 according to embodiments of the invention. As shown by image 510, local orientation in a number of regions may be calculated and presented.

A system or method may calculate a 2-dimensional scalar field of a local tangent orientation. The term “local tangent orientation” may be similar to the local orientation angle and/or the angular-gradient described herein.

In an embodiment, statistical analysis may be used to calculate a 2-dimensional scalar field of a local tangent orientation. For example, in an embodiment, a module receives as input a 2-dimensional scalar field (e.g., a grayscale image) with one or more periodic one dimensional pattern and generates or returns a 2-dimensional scalar field of the local tangent orientation in a finite neighborhood. For example, arrows or other graphical objects may be used to show or indicate a local tangent orientation of points along a row of trees (or other objects) in an image. An advantage of a map that shows the local tangent orientation, e.g., continuously over an image, may be by using the map in order to identify order in objects in the image. For example, a map that includes the local tangent orientation and/or a representation of the local tangent orientation may be used to identify rows of objects, such as trees in an image.

A 2-dimensional scalar field input may be an original grayscale image, e.g., an image such as image 210 in FIG. 2. A system or method may include convoluting an input (or original) grayscale image with a Gaussian-gradient filter. For example, two gradient-filtered grayscale images may be described (and/or generated) using a gray-level tensor h^{G}ᵢⱼₖ, e.g., a tensor defined by h_{ijα}^{G}≡h(xᵢ,yⱼ; α=x,y). Values for the tensor may be produced by convoluting an input grayscale image with a Gaussian-gradient filter. In an embodiment, the gray-level tensor, h^{G}ᵢⱼₖ is defined by:

$${h}_{ijx}^{G} = {\sum }_{\vert m \vert < {𝓁}_{x} \text{/} 2 , \vert n \vert < {𝓁}_{y} \text{/} 2} {h}_{i + m , j + n} \cdot {f}_{mnx}^{G}$$

$${h}_{ify}^{G} = {\sum }_{\vert m \vert < {𝓁}_{x} \text{/} 2 , \vert n \vert < {𝓁}_{y} \text{/} 2} {h}_{i + m , j + n} \cdot {f}_{mny}^{G}$$

where lₓ=N_{σ}·σ and l_{y}=N_{σ}·σ define the convolution window size (filter window size) in units of pixels, σ and N_{σ} are the Gaussian standard deviation and the extent of window size, respectively, and the convolution functions are given by:

$${f}_{mnx}^{G} = - \frac{m Δ x}{{σ}^{2}} \cdot \frac{1}{\sqrt{2 π } σ} {e}^{- \frac{{m}^{2} Δ {x}^{2} + {n}^{2} Δ {y}^{2}}{2 {σ}^{2}}}$$

$${f}_{mny}^{G} = - \frac{n Δ y}{{σ}^{2}} \cdot \frac{1}{\sqrt{2 π} σ} {e}^{- \frac{{m}^{2} Δ {x}^{2} + {n}^{2} Δ {y}^{2}}{2 {σ}^{2}}}$$

A system and method may include calculating an angular-gradient for points in an image using a gray-level tensor. For example, the angular-gradient of coordinate (i,j) may be given by h^{a}ᵢⱼ defined by:

$${h}_{ij}^{A} = {tan}^{- 1} ( \frac{{h}_{ijy}^{G}}{{h}_{ijx}^{G}} )$$

Values of h^{a}ᵢⱼ (e.g., as calculated for all pixels in an image) may be used to select, calculate or determine a local orientation angle αᵢⱼ for a point at coordinates (i,j). For example, in an embodiment, a local orientation angle αᵢⱼ is determined by calculating or identifying the most frequent value in a histogram formed using all the elements of hᵢⱼ^{A} within a window of size lₓ×l_{y} around the element or point (i,j).

A system and method may verify or determine a precision or accuracy of a local orientation or angle αᵢⱼ. A local orientation or angle αᵢⱼ, may indicate or represent a one dimensional periodic pattern within a neighborhood of size lₓ×l_{y}.

A system and method may receive an input 2-dimensional scalar field of a local tangent orientation (e.g., generated as described herein) related to in a finite neighborhood. For example, values of the local tangent orientation for a set of pixels (i,j) may be provided in an input 2-dimensional scalar field of a local tangent orientation.

A system and method may calculate, determine and/or provide a classification (e.g., CLEAR or COMPLEX) for a given set of pixels, regions in an image and/or even for a single pixel. For example, a classification of a region or pixel as “CLEAR” may indicate that a dominant directionality for the region or pixel is validated. Similarly, a classification or a region or pixel as “COMPLEX” may be used to indicate vague detection of directionality that may require further inspection or processing.

A 2-dimensional scalar field input may be provided with corresponding angular orientation matrix αᵢⱼ. For example, angular orientation matrix αᵢⱼ may be computed or calculated for an input image or other 2-dimensional scalar field and both the input image and matrix αᵢⱼ may be provided as input to a module or method.

A system or method may divide a region or neighborhood, e.g., around a selected pixel, into grid-cells. For example, in an embodiment, at each pixel, the neighborhood corresponding to the detected orientation αᵢⱼ is divided into pixel-width longitudinal bins or grid-cells. In an embodiment, longitudinal bins are defined by dividing a window to stripes (e.g., stripes of 1-pixel width) where the direction of the stripes is parallel to the locally detected direction alphaᵢⱼ, along the locally detected direction αᵢⱼ.

In an embodiment, grid-cell, the fraction of pixels in hᵢⱼ that exceeds a predetermined threshold is counted and/or recorded, yielding or producing a one dimensional function of the fraction of above-threshold pixels vs. (or as a function of) the perpendicular (to αᵢⱼ) axis. In an embodiment, the one dimensional function is analyzed. For example, the number of peaks that exceed a first predetermined threshold is determined or recorded and/or the number of peaks that exceed a second predetermined threshold, to assess the confidence of the detected orientation. Similarly, the number of dips that fall below a predetermined threshold may be recorded.

For example, the number of rows along the detected direction is counted and used in an assessment whether the detected direction is valid. For example, if indeed the detected direction is correct then the number of expected well-defined rows is high as compared to a case where either the detected direction is wrong or the rows aren't well-defined.

Based on the peak count and the distances of the peaks from each other, and from the ends, the pixel, corresponding to a lₓ×l_{y} neighborhood is classified as either CLEAR or COMPLEX. For example, the lₓ×l_{y} neighborhood may be a 16×16 pixel window around the pixel being classified. Operations and logic described herein with respect to peaks may be applied to dips. It will therefore be understood that, as described herein, a system and method may count the number of peaks and dips in a grid-cell or along a bin as described herein, record the distances between peaks and dips in the grid-cell, record the distances from borders of the grid-cell to peaks and dips in the grid-cell, and use the recorded data to produce a verification of a local tangent orientation associated with the grid-cell based on the recorded distances and the thresholds.

Based on the peak count and the distances of the peaks from each other, distances of the peaks from the ends, a system and method may classify the pixel corresponding to a lₓ×l_{y} neighborhood as either “CLEAR” or “COMPLEX”. A pixel classified as “CLEAR” may be considered valid or verified and a pixel or region classified as “COMPLEX” may be considered invalid or unverified.

A system and method may delineate the interface line between a first and second region in an image, the first and second regions having a respective first and second local tangent orientations. For example, provided with an image (e.g., grayscale image) of a planted forest, a system and method may produce a map of the local row direction in the planted forest and may delineate the interface line between two regions in the planted forest that have different local tangent orientation. For example, the interface or border line 525 in image 511 may be determined or identified such that it separates regions 515 and 520 that have different local tangent orientation as shown.

A system and method may receive a 2-dimensional scalar field input of a local tangent orientation (e.g., generated as described herein) related to in a neighborhood. For example, values of the local tangent orientation for a set of pixels (i,j) may be provided in an input 2-dimensional scalar field of a local tangent orientation. A system and method may examine and/or process a 2-dimensional scalar field of a local tangent orientation to define, produce and/or present borderlines between regions with different orientations.

A system and method may identify discontinuous changes in the local curve orientation and define, produce and/or present borderlines between regions based on the discontinuous changes. For example, a border line 525 between regions 515 and 520 may be defined, produced and/or presented as shown by image 511. For example. A system and method may group together sets of grid-cells in an image, each set associated with a common local tangent orientation, defining regions in the image based on the sets of grid-cells and define a curve separating regions in the image.

A system and method may detecting intervals along a curve that is defined based on bright pixels (pixels with densities above a threshold value), and identifying rows based on the intervals. A system and method may generate a matrix \tilde{α}ᵢⱼ based on local orientation angle as represented or defined by the αᵢⱼ matrix described herein. A system or method may define N_{c} classes by allocating an equal interval of π/N_{c} to all N_{c} classes. In embodiments, classes are defined such that each class is associated with a corresponding interval. The various class intervals do not overlap, and together they form the whole angular interval between 0 to π. Accordingly, a pixel (i,j) may be classified by matching the value of aᵢⱼ to the corresponding interval, thus assigning a class to the pixel (i,j). For example, in an embodiment, all entries in αᵢⱼ are assigned to a corresponding class, thus creating matrix \tilde{α}ᵢⱼ. Accordingly, the values of \tilde{α}ᵢⱼ are discrete within the range 1, 2 . . . N_{c}.

A system and method may define a homogenous region as a connected region in \tilde{α}ᵢⱼ. For example, in an embodiment, a homogenous region is defined by all entries in \tilde{α}ᵢⱼ that have the same value. Values of \tilde{α}ᵢⱼ may be obtained by iterating over all (i,j) in the space as known in the art.

A system and method may determine, generate and/or present the trajectory of an interfacial line separating two adjacent homogeneous regions Tᵢⱼ by numerically calculating the magnitude of local gradients in \tilde{α}ᵢⱼ:

$${T}_{ij} = \frac{1}{2} \sqrt{{( \frac{{\tilde{α}}_{i + 1 , j} - {\tilde{α}}_{i - 1 , j}}{Δ x} )}^{2} + {( \frac{{\tilde{α}}_{i , j + 1} - {\tilde{α}}_{i , j - 1}}{Δ y} )}^{2}} .$$

A borderline or a trajectory of an interfacial line between regions may be determined, generated, defined and/or presented by identifying is given by the loci where Tᵢⱼ>0. For example, points or pixels in location (i,j) in image 511 may be marked as a borderline or an interfacial line if Tᵢⱼ>0.

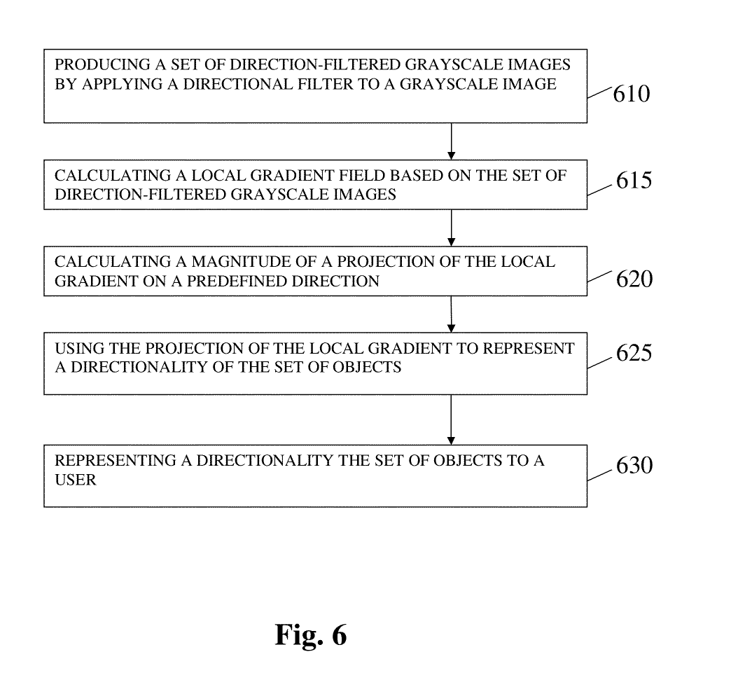

Reference is made to FIG. 6, a flow according to embodiments of the present invention.

As shown by block 610, a method or flow may include producing a set of direction-filtered grayscale images by applying a directional filter to a grayscale image. For example, using a tensor as described a direction-filtered grayscale image as shown by image 220 in FIG. 2 may be produced.

As shown by block 615, a method or flow may include calculating a local gradient field (or local orientation angle) based on a set of direction-filtered grayscale images. For example and as described, a local gradient field may be generated by associating pixels in an image with local gradient values or vectors based on the local gradient at the locations of the pixels.

As shown by block 620, a method or flow may include calculating a magnitude of a projection of the local gradient on a predefined direction. For example, a magnitude Jᵢⱼₖₗ of a projection of the local gradient in a direction-filtered image may be calculated as described herein.

As shown by block 625, a method or flow may include using the projection to represent a directionality of the set of objects. For example, a directionality of a set of trees in an image may be calculated and presented, e.g., such that rows of trees are identified in an image. Using the projection may include applying an averaging filter to the magnitude of the projection to produce a smoothed set of images having a respective set of smoothed gradient magnitude projections, calculating a local projection asymmetry based on a difference between at least two values of smoothened gradient projections and calculating a local orientation angle based on the local projection asymmetry. For example, a local orientation angle may be calculated by determining a maximal local projection asymmetry.

As shown by block 630, a method or flow may include representing a directionality the set of objects to a user. For example, rows of trees may be identified in an image and the directions of the rows may be displayed on a monitor of a computer. For example, small arrows placed on an image may indicate rows of trees and their directions. Arrows or other graphical objects may be used to show or indicate a local direction (or local tangent orientation) of points along a row of trees in an image. A map that shows the direction of a row of trees, e.g., continuously over an image, may be presented on a monitor of a computer. For example, arrows may be overlaid on a map where the arrows point in the direction of a row of trees.

Some embodiments may be provided in a computer program product that may include a non-transitory machine-readable medium, stored thereon instructions, which may be used to program a computer, or other programmable devices, to perform, when executed, methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. For example, memory 120 may be a non-transitory machine-readable medium.

A system according to embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a notebook computer, a workstation, a server computer, a network device, or any other suitable computing device. For example, a system as described herein may include one or more devices such as computing device 100.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of representing a directionality of a set of objects in an image, the method comprising:
providing a 2-dimensional scalar field representing a grayscale image;
producing a set of direction-filtered grayscale images by applying a directional filter to the 2-dimensional scalar field with varying filter-directionality;
calculating a local gradient field based on the set of direction-filtered grayscale images;
calculating a magnitude of a projection of the local gradient on a predefined direction; and
using the projection of the local gradient to represent a directionality of the set of objects by providing a representation of a local tangent orientation for the set of objects.

2. The method of claim 1, further comprising:
applying an averaging filter to the magnitude of the projection to produce a smoothed set of images having a respective set of smoothed gradient magnitude projections;
calculating a local projection asymmetry based on the difference between at least two values of smoothened gradient projections; and
calculating a local orientation angle based on the local projection asymmetry.

3. The method of claim 2, further comprising calculating the local orientation angle by determining a maximal local projection asymmetry.

4. The method of claim 1, further comprising:
representing the local tangent orientation using a 2-dimensional scalar field;
for each pixel of at least some of the pixels in the 2-dimensional scalar field:
placing a set of grid-cells along a direction set based on the local tangent orientation in the neighborhood of the pixel;
for each of the grid-cells, counting pixels having a grayscale level value that exceeds a predefined threshold; and
plotting a curve of bright pixel densities based on the number of pixels having a grayscale level value that exceeds a predefined threshold as a function of the axis perpendicular to the local tangent orientation.

5. The method of claim 4, further comprising detecting intervals along the curve based on a threshold value of bright pixel densities and identifying rows based on the intervals.

6. The method of claim 1, further comprising:
detecting peaks and dips of grayscale level values of pixels in a set of grid-cell in the image; and
for each of the grid-cells:
counting the number of peaks and dips in the grid-cell,
recording the distances between peaks and dips in the grid-cell;
recording the distances from borders of the grid-cell to peaks and dips in the grid-cell,
producing a verification of a local tangent orientation associated with the grid-cell based on the recorded distances and one or more thresholds.

7. The method of claim 1, further comprising:
assigning a set of classification values to a respective set of orientation of angles detected in the image; and
classifying a set of grid-cells in the image based on their respective local tangent orientation and based on the classification values.

8. The method of claim 1, further comprising:
grouping sets of grid-cells in the image, each set associated with a common local tangent orientation;
defining regions in the image based on the sets of grid-cells; and
defining a curve separating regions in the image.

9. A method of calculating a local orientation angle for a digital grayscale image, the method comprising:
providing a 2-dimensional input digital grayscale image, the gray scale image having a periodic one dimensional pattern, the image includes a set of grayscale values of a respective set of pixels in the input digital grayscale image;
providing a 2-dimensional scalar field representing a grayscale image, the scalar field having a periodic one dimensional pattern;
generating at least two gradient-filtered grayscale images using a gray-level tensor;
generating an angular-gradient grayscale image based on the gradient-filtered grayscale images;
associating a local orientation angle with pixels in the input digital grayscale image based on analysis of the angular-gradient grayscale image; and
associating a local orientation angle with pixels in the input digital grayscale image based on the angular-gradient grayscale image.

10. The method of claim 9, further comprising:
assigning a set of classification values to a respective set of local orientation angles detected in the image; and
classifying a set of grid-cells in the image based on their respective local orientation angles and based on the classification values.

11. The method of claim 9, further comprising:
grouping sets of grid-cells in the image, each set associated with a common local orientation angle;
defining regions in the image based on the sets of grid-cells; and
defining a curve separating regions in the image.

12. An article comprising a computer-readable storage medium, having stored thereon instructions, that when executed by a controller, cause the controller to:
receive a 2-dimensional scalar field representing a grayscale image;
produce a set of direction-filtered grayscale images by applying a directional filter to the 2-dimensional scalar field with varying filter-directionality;
calculate a local gradient field based on the set of direction-filtered grayscale images;
calculate a magnitude of a projection of the local gradient on a predefined direction; and
use the projection of the local gradient to represent a directionality of the set of objects by providing a representation of a local tangent orientation for the set of objects.

13. The article of claim 12, wherein the instructions when executed further result in:
applying an averaging filter to the magnitude of the projection to produce a smoothed set of images having a respective set of smoothed gradient magnitude projections;
calculating a local projection asymmetry based on the difference between at least two values of smoothened gradient projections; and
calculating a local orientation angle based on the local projection asymmetry.

14. The article of claim 13, wherein the instructions when executed further result in calculating the local orientation angle by determining a maximal local projection asymmetry.

15. The article of claim 12, wherein the instructions when executed further result in:
representing the local tangent orientation using a 2-dimensional scalar field;
for each pixel of at least some of the pixels in the 2-dimensional scalar field:
placing a set of grid-cells along a direction set based on the local tangent orientation in the neighborhood of the pixel;
for each of the grid-cells, counting pixels having a grayscale level value that exceeds a predefined threshold; and
plotting a curve of bright pixel densities based on the number of pixels having a grayscale level value that exceeds a predefined threshold as a function of the axis perpendicular to the local tangent orientation.

16. The article of claim 15, wherein the instructions when executed further result in detecting intervals along the curve based on a threshold value of bright pixel densities and identifying rows based on the intervals.

17. The article of claim 12, wherein the instructions when executed further result in:
detecting peaks and dips of grayscale level values of pixels in a set of grid-cell in the image; and
for each of the grid-cells:
counting the number of peaks and dips in the grid-cell,
recording the distances between peaks and dips in the grid-cell;
recording the distances from borders of the grid-cell to peaks and dips in the grid-cell,
producing a verification of a local tangent orientation associated with the grid-cell based on the recorded distances and one or more thresholds.

18. The article of claim 13, wherein the instructions when executed further result in:
assigning a set of classification values to a respective set of orientation of angles detected in the image; and
classifying a set of grid-cells in the image based on their respective local tangent orientation and based on the classification values.

19. The article of claim 13, wherein the instructions when executed further result in:
grouping sets of grid-cells in the image, each set associated with a common local tangent orientation;
defining regions in the image based on the sets of grid-cells; and
defining a curve separating regions in the image.

20. The article of claim 12, wherein the instructions when executed further result in:
generating at least two gradient-filtered grayscale images using a gray-level tensor;
generating an angular-gradient grayscale image based on the gradient-filtered grayscale images;
associating a local orientation angle with pixels in the input digital grayscale image based on analysis of the angular-gradient grayscale image; and
associating a local orientation angle with pixels in the input digital grayscale image based on the angular-gradient grayscale image.
